(19) United States
(12) Patent Application Publication
(10) Pub. No.: US 2011/0200263 A1
(43) Pub. Date: Aug. 18, 2011

(54) IMAGE ENCODER AND IMAGE DECODER

(75) Inventor: Mayu OGAWA, Osaka (JP)

(73) Assignee: PANASONIC CORPORATION, Osaka (JP)

(21) Appl. No.: 13/094,285

(22) Filed: Apr. 26, 2011

Related U.S. Application Data
(63) Continuation of application No. PCT/JP2009/006058, filed on Nov. 12, 2009.

(30) Foreign Application Priority Data
Jan. 19, 2009 (JP) 2009-009180

(51) Int. Cl. G06K 9/36

(52) U.S. Cl. 382/233; 382/238

(57) ABSTRACT

An image encoder is provided which receives pixel data of N bits, where N is a natural number, and in which a difference generator calculates a difference between a pixel to be encoded, and a predicted value generated based on at least one pixel located around the pixel to be encoded, a quantizer quantizes a value obtained by subtracting a first offset value from the prediction difference value, and an adder adds the quantized value and a second offset together. An encoded predicted value decider predicts, based on a signal level of the predicted value, an encoded predicted value which is a signal level of the predicted value after encoding. A result of addition of the quantized value and the second offset value is added to or subtracted from the encoded predicted value to obtain encoded data of M bits, where M is a natural number, and N>M.

### CROSS-REFERENCE TO RELATED APPLICATIONS

This is a continuation of PCT International Application PCT/JP2009/006058 filed on Nov. 12, 2009, which claims priority to Japanese Patent Application No. 2009-009180 filed on Jan. 19, 2009. The disclosures of these applications including the specifications, the drawings, and the claims are hereby incorporated by reference in their entirety.

### BACKGROUND

The present disclosure relates to image encoders and image decoders which are used in apparatuses which process images, such as digital still cameras, network cameras, printers, etc., to employ image compression in order to speed up data transfer and reduce the required capacity of memory.

In recent years, as the number of pixels in an imaging element used in an imaging apparatus, such as a digital still camera, a digital camcorder, etc. has been increased, the amount of image data to be processed by an integrated circuit included in the apparatus has increased. To deal with a large amount of image data, it is contemplated that an operating frequency may be sped up, the required capacity of memory may be reduced, etc. in order to ensure a sufficient bus width for data transfer in the integrated circuit. These measures, however, may directly lead to an increase in cost.

In imaging apparatuses, such as digital cameras, digital camcorders, etc., after all image processes are completed in the integrated circuit, data is typically compressed before being recorded into an external recording device, such as an SD card etc. In this case, therefore, images having larger sizes or a larger number of images can be stored into an external recording device having the same capacity, compared to when the data is not compressed. The compression process is achieved using an encoding technique, such as JPEG, MPEG, etc.

Japanese Patent Publication No. 2007-036566 describes a technique of performing a compression process not only on data which has been subjected to image processing, but also on a pixel signal (RAW data) input from the imaging element, in order to increase the number of images having the same size which can be shot in a single burst, using the same memory capacity. This technique is implemented as follows. A quantization width is decided based on a difference value between a pixel to be compressed and its adjacent pixel, and an offset value which is uniquely calculated from the quantization width is subtracted from the value of the pixel to be compressed, thereby deciding a value to be quantized. As a result, a digital signal compression (encoding) and decompression (decoding) device is provided which achieves a compression process while ensuring a low encoding load, without the need of memory.

Japanese Patent Publication No. H10-056638 describes a technique of compressing (encoding) image data, such as a TV signal etc., recording the compressed data into a recording medium, and decompressing the compressed data in the recording medium and reproducing the decompressed data. This technique is implemented as follows. Predictive encoding is quickly performed using a simple adder, subtractor, and comparator without using a ROM table etc. Moreover, each quantized value itself is caused to hold absolute level information, whereby error propagation which occurs when a predicted value is not correct is reduced.

### SUMMARY

In the digital signal compression (encoding) device described in Japanese Patent Publication No. 2007-036566, however, a zone quantization width decider quantizes all pixels contained in a “zone” using a single quantization width (zone quantization width), where the “zone” refers to a group including a plurality of neighboring pixels. The zone quantization width is equal to a difference between a value obtained by adding one to a quantization range corresponding to a greatest pixel value difference which is a greatest of difference values between the values of pixels contained in the zone and the values of their neighboring pixels having the same color, and the number s of bits in data obtained by compressing pixel value data (i.e., “compressed pixel value data bit number (s)”). In other words, even if there is a sharp edge in a zone, and only one pixel has a great difference value, all the other pixels in the same zone are affected by the one pixel, resulting in a great quantization width. Therefore, even if the difference value is small and therefore quantization is not substantially required, an unnecessary quantization error occurs. To solve this problem, it is contemplated that the number of pixels in a zone may be reduced. In this case, however, the number of bits in zone quantization width information which is added on a zone-by-zone basis increases, and therefore, the compression ratio of encoding decreases.

In contrast to this, in the image encoder described in Japanese Patent Publication No. H10-056638, a linear quantized value generator performs division by two raised to the power of K (K is a predetermined linear quantization width) to obtain a linear quantized value. Next, a nonlinear quantized value generator calculates a difference value between a predicted value and an input pixel value, and based on the result, calculates correction values for several patterns. Based on the previously calculated difference value, it is determined which of the correction values is to be employed, thereby obtaining a quantized value and a reproduced value. Thus, an input pixel value is converted into a quantized value. The quantized value and a reproduced value which is the next predicted value are selected from the results of calculation for several patterns based on the difference value between the predicted value and the input pixel value. Therefore, when a difference in dynamic range between the input signal, and the output signal after encoding, is great and therefore high compression is required, the number of patterns of correction values increases. In other words, the number of patterns for calculation expressions of correction values is increased, disadvantageously resulting in an increase in the amount of calculation (circuit size).

On the other hand, in image processing performed in an integrated circuit which is typically included in a digital still camera etc., a digital pixel signal input from the imaging element is temporarily stored in a memory device, such as an synchronous dynamic random access memory (SDRAM) device etc., predetermined image processing, YC signal generation, zooming (e.g., enlargement/reduction etc.), etc. is performed on the temporarily stored data, and the resultant data is temporarily stored back into the SDRAM device. In this case, when data is read from any arbitrary region of an image, when an image process which needs to reference or calculate a correlation between upper and lower pixels is performed, etc., it is often necessary to read pixel data from an arbitrary region of the memory device. In this case, it is not possible to read an arbitrary region from an intermediate point in variable-length encoded data, and therefore, the random access ability is impaired.

The present disclosure describes implementations of a technique of performing quantization on a pixel-by-pixel basis while maintaining the random access ability by performing fixed-length encoding, and without adding information other than pixel data, such as quantization information etc., thereby achieving high compression while reducing or preventing a degradation in image quality.

The present disclosure focuses on the unit of data transfer in an integrated circuit, and guarantees the fixed length of the bus width of the data transfer, thereby improving a compression ratio in the transfer unit.

An example image encoder is provided for receiving pixel data having a dynamic range of N bits, nonlinearly quantizing a difference between a pixel to be encoded and a predicted value to obtain a quantized value, and representing encoded data containing the quantized value by M bits, to compress the pixel data into a fixed-length code, where N and M are each a natural number and N>M. The image encoder includes a predicted pixel generator configured to generate a predicted value based on at least one pixel located around the pixel to be encoded, an encoded predicted value decider configured to predict, based on a signal level of the predicted value, an encoded predicted value which is a signal level of the predicted value after encoding, a difference generator configured to obtain a prediction difference value which is a difference between the pixel to be encoded and the predicted value, a quantization width decider configured to decide a quantization width based on the number of digits of an unsigned integer binary value of the prediction difference value, a value-to-be-quantized generator configured to generate a value to be quantized by subtracting a first offset value from the prediction difference value, a quantizer configured to quantize the value to be quantized based on the quantization width decided by the quantization width decider, and an offset value generator configured to generate a second offset value. A result of addition of a quantized value obtained by the quantizer and the second offset value is added to or subtracted from the encoded predicted value, depending on the sign of the prediction difference value, to obtain the encoded data.

According to the present disclosure, a quantization width is decided on a pixel-by-pixel basis, and encoding can be achieved by fixed-length encoding without adding a quantization width information bit. Therefore, when a plurality of portions of generated encoded data having a fixed length are stored in a memory etc., encoded data corresponding to a pixel located at a specific position in an image can be easily identified. As a result, random access ability to encoded data can be maintained.

Thus, according to the present disclosure, a degradation in image quality can be reduced or prevented compared to the conventional art, while maintaining the random access ability to a memory device.

### BRIEF DESCRIPTION OF THE DRAWINGS

FIG. 1 is a block diagram showing a configuration of an image encoder according to a first embodiment.

FIG. 2 is a flowchart showing a process performed by the image encoder of FIG. 1.

FIG. 3 is a diagram for describing a prediction expression in a predicted pixel generator of FIG. 1.

FIG. 4 is a diagram showing an example encoding process and results of calculations.

FIG. 5 is a diagram showing a relationship between each calculation result in the example encoding process.

FIG. 6 is a diagram showing an example calculation of an encoded predicted value.

FIG. 7 is a diagram showing a relationship between prediction difference absolute values and quantization widths.

FIG. 8 is a diagram showing characteristics between input pixel data, and encoded pixel data obtained from predicted values of the input pixel data.

FIG. 9 is a diagram showing example encoded data output by an output section of FIG. 1.

FIG. 10 is a block diagram showing a configuration of an image decoder according to the first embodiment.

FIG. 11 is a flowchart showing a process performed by the image decoder of FIG. 10.

FIG. 12 is a diagram showing an example decoding process and results of calculations.

FIG. 13 is a block diagram showing a digital still camera according to a second embodiment.

FIG. 14 is a block diagram showing a configuration of a digital still camera according to a third embodiment.

FIG. 15 is a block diagram showing a configuration of a personal computer and a printer according to a fourth embodiment.

FIG. 16 is a block diagram showing a configuration of a surveillance camera according to a fifth embodiment.

FIG. 17 is a block diagram showing another configuration of the surveillance camera of the fifth embodiment.

### DETAILED DESCRIPTION

Embodiments of the present disclosure will be described hereinafter with reference to the accompanying drawings. Note that like parts are indicated by like reference characters.

### First Embodiment

### Encoding Process in Image Encoder 100

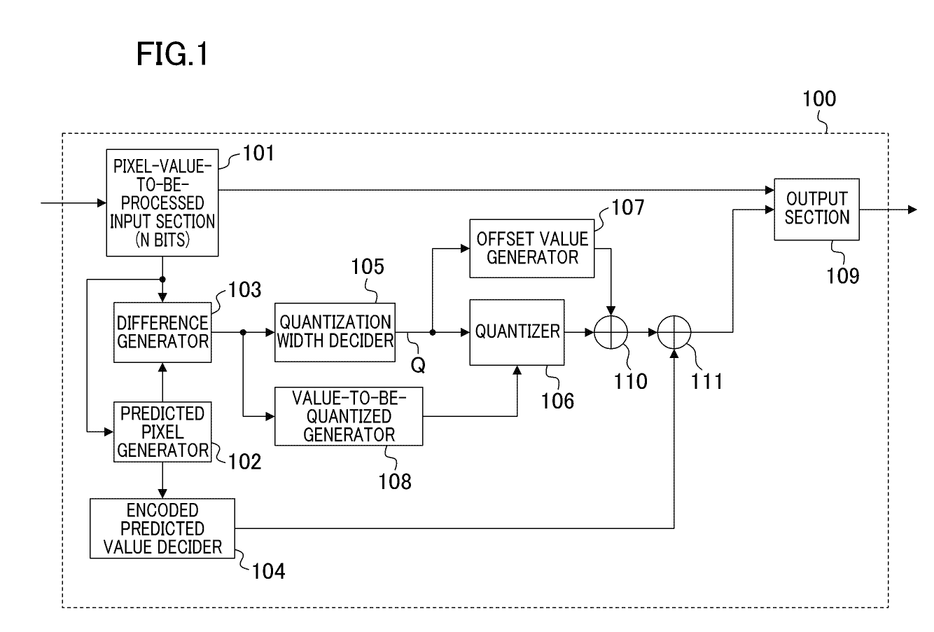

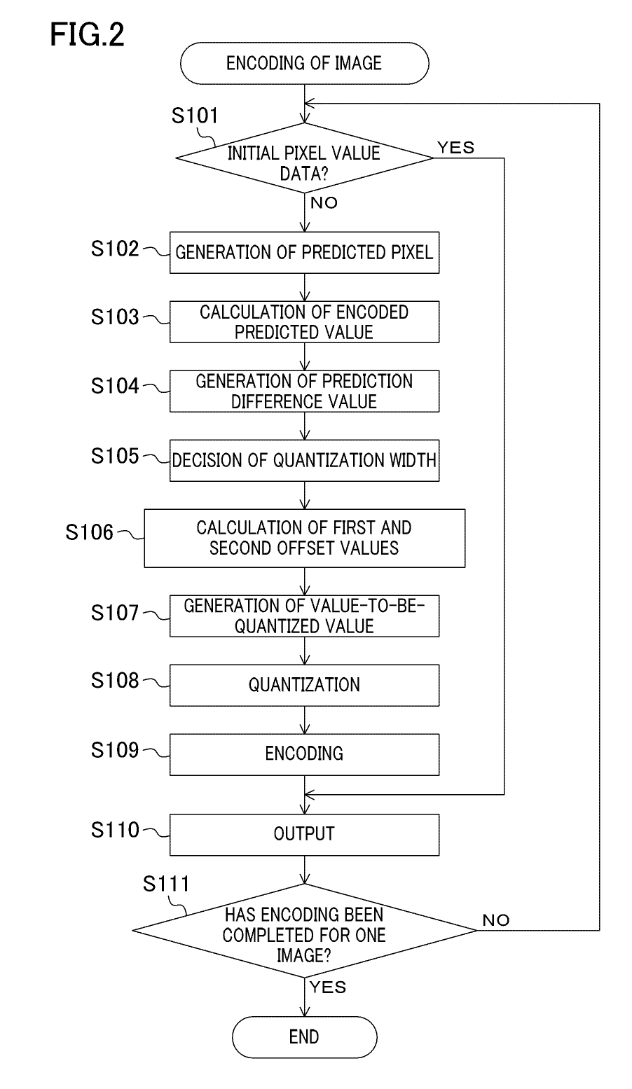

FIG. 1 is a block diagram showing a configuration of an image encoder 100 according to a first embodiment of the present disclosure. FIG. 2 is a flowchart of an image encoding process. A process of encoding an image which is performed by the image encoder 100 will be described with reference to FIGS. 1 and 2.

Pixel data to be encoded is input to a pixel-value-to-be-processed input section 101. In this embodiment, it is assumed that each pixel data is digital data having a length of N bits, and encoded data has a length of M bits. The pixel data input to the pixel-value-to-be-processed input section 101 is output to a predicted pixel generator 102 and a difference generator 103 with appropriate timing. Note that when a pixel of interest which is to be encoded is input as initial pixel value data, the pixel data is directly input to an output section 109 without being quantized.

When a pixel of interest which is to be encoded is not initial pixel value data (NO in step S101 of FIG. 2), control proceeds to a predicted pixel generation process (step S102 of FIG. 2). Pixel data which is input to the predicted pixel generator 102 is any one of initial pixel value data which has been input before the pixel of interest which is to be encoded, a previous pixel value to be encoded, and pixel data which has been encoded, and transferred to and decoded by an image decoder before the pixel of interest. The predicted pixel generator 102 uses the input pixel data to generate a predicted value of the pixel data of interest (step S102 of FIG. 2).

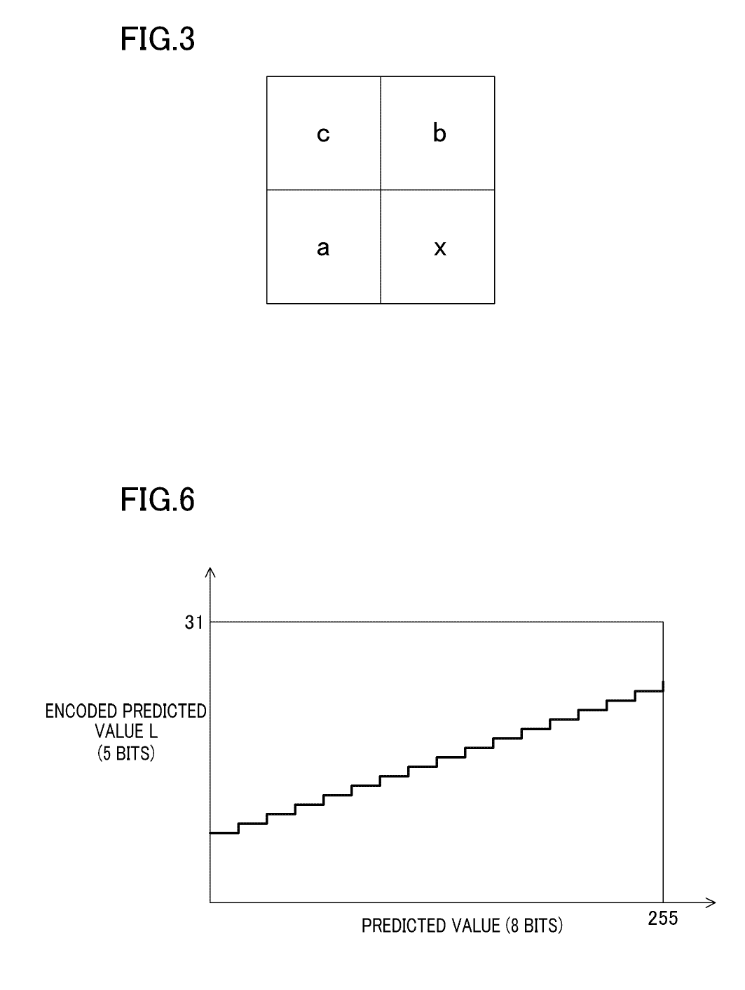

There is a known technique of encoding pixel data which is called predictive encoding. Predictive encoding is a technique of generating a predicted value for a pixel to be encoded, and quantizing a difference value between the pixel to be encoded and the predicted value. In the case of pixel data, based on the fact that it is highly likely that the values of adjacent pixels are the same as or close to each other, the difference value is reduced to the extent possible by predicting the value of a pixel of interest which is to be encoded, based on neighboring pixel data, thereby reducing the quantization width. FIG. 3 is a diagram for describing an arrangement of neighboring pixels which are used in calculation of a predicted value, where “x” indicates the pixel value of a pixel of interest, and “a,” “b,” and “c” indicate the pixel values of neighboring pixels for calculating a predicted value “y” of the pixel of interest. The predicted value “y” may be calculated by any of the following expressions.

y=a (1)

y=b (2)

y=c (3)

y=a+b−c (4)

y=a+(b−c)/2 (5)

y=b+(a−c)/2 (6)

y=(a+b)/2 (7)

Thus, the predicted value “y” of the pixel of interest using the pixel values “a,” “b,” and “c” of the neighboring pixels of the pixel of interest is calculated. A prediction error Δ (=y−x) between the predicted value “y” and the pixel to be encoded “x” is calculated. The prediction error Δ is encoded.

The predicted pixel generator 102 calculates a predicted value from input pixel data using one of the prediction expressions (1)-(7), and outputs the calculated predicted value to the difference generator 103. Note that the present disclosure is not limited to the above prediction expressions. If a sufficient internal memory buffer is provided for the compression process, the values of pixels farther from the pixel of interest than the adjacent pixels may be stored in the memory buffer and used for prediction to improve the accuracy of the prediction.

The difference generator 103 generates a difference (hereinafter referred to as a prediction difference value) between the value of a pixel to be encoded received from the pixel-value-to-be-processed input section 101 and a predicted value received from the predicted pixel generator 102. The generated prediction difference value is transferred to a quantization width decider 105 and a value-to-be-quantized generator 108 (step S104 of FIG. 2).

An encoded predicted value decider 104 predicts a bit length of encoded data after encoding (i.e., an encoded predicted value L which is a signal level of a predicted value represented by M bits) based on a signal level of a predicted value represented by N bits. Therefore, the encoded predicted value L indicates the signal level of a predicted value represented by N bits as it will be encoded into M bits (step S103 of FIG. 2).

The quantization width decider 105 decides a quantization width Q based on a prediction difference value corresponding to each pixel to be encoded, which has been received from the difference generator 103, and outputs the quantization width Q to a quantizer 106 and an offset value generator 107. The quantization width Q refers to a value which is obtained by subtracting a predetermined non-quantization range NQ (unit: bit), where NQ is a natural number, from the number of digits of a binary representation of the absolute value of a prediction difference value (hereinafter referred to as a prediction difference absolute value). In other words, the quantization width Q refers to a value which is obtained by subtracting NQ from the number of digits (the number of bits) required for an unsigned integer binary representation of a prediction difference value (step S105 of FIG. 2). For example, assuming that the number of digits of the unsigned integer binary representation of a prediction difference value is d, the quantization width Q is calculated by:

Q=d−NQ (8)

Here, it is assumed that the non-quantization range NQ indicates that the range of a prediction difference value which is not quantized is two raised to the power of NQ (i.e., 2̂NQ), and is previously decided and stored in an internal memory buffer of the image encoder 100. Assuming that a pixel to be encoded has a signal level close to the signal level of the predicted value, the quantization width decider 105 sets the quantization width Q to increase as the signal level of the pixel to be encoded progresses away from the predicted value, based on expression (8). Note that, in the case of expression (8), as the number d of digits of the unsigned integer binary representation of the prediction difference value increases, the quantization width Q also increases. It is also assumed that the quantization width Q takes no negative value.

The value-to-be-quantized generator 108 calculates a signal level of a pixel data to be quantized, based on a prediction difference value corresponding to each pixel to be encoded, which has been received from the difference generator 103. For example, when the number of digits of the unsigned integer binary representation of the prediction difference value is d, the value-to-be-quantized generator 108 calculates a first offset value to be 2̂(d−1), and generates a value which is obtained by subtracting the first offset value from the prediction difference absolute value, as the signal level of the pixel data to be quantized, i.e., a value to be quantized, and transmits the value to the quantizer 106 (steps S106 and S107 of FIG. 2).

The offset value generator 107 calculates a second offset value F from the quantization width Q received from the quantization width decider 105. The second offset value F is, for example, calculated by:

F=(2̂(NQ−1))×(Q−1)+2̂NQ (9)

In this case, because NQ indicates the predetermined non-quantization range, the quantization width Q varies depending on a difference value between a pixel to be encoded and a predicted value corresponding to the pixel to be encoded, and the second offset value F also varies depending on the variation of the quantization width Q. In other words, as the quantization width Q increases, the second offset value F also increases, based on expression (9) (step S106 of FIG. 2).

The quantizer 106 performs a quantization process to quantize the value to be quantized received from the value-to-be-quantized generator 108, based on the quantization width Q calculated by the quantization width decider 105. Note that the quantization process based on the quantization width Q is a process of dividing a value to be quantized corresponding to a pixel to be encoded by two raised to the power of Q. Note that the quantizer 106 does not perform quantization when the quantization width Q is “0” (step S108 of FIG. 2).

The quantization result output from the quantizer 106 and the second offset value F output from the offset value generator 107 are added together by an adder 110. Pixel data (hereinafter referred to as quantized pixel data) output from the adder 110, and the encoded predicted value L received from the encoded predicted value decider 104, are added together by an adder 111 to generate pixel data (hereinafter referred to as encoded pixel data) represented by M bits (step S109 of FIG. 2). The encoded pixel data generated by the adder 111 is transmitted from the output section 109 (step S110 of FIG. 2).

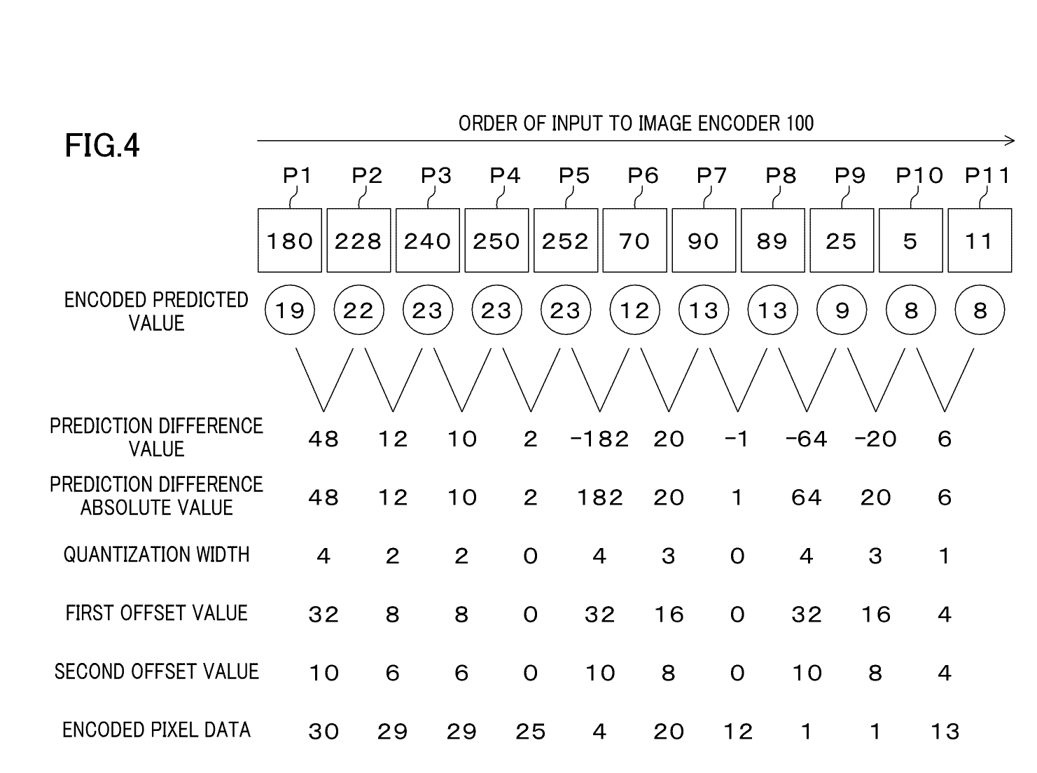

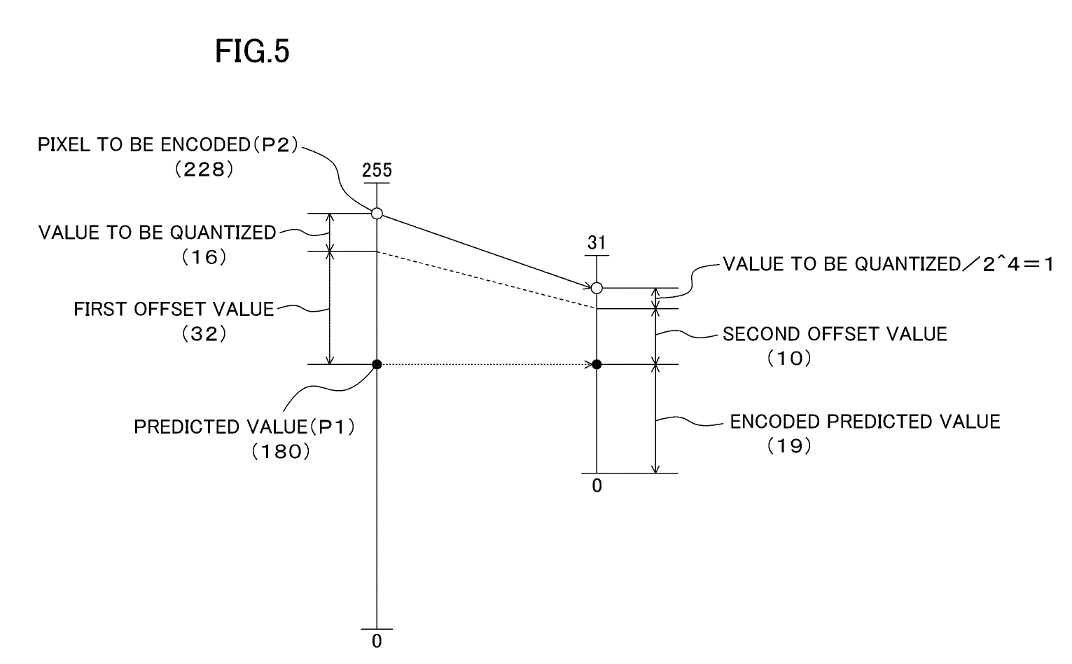

FIGS. 4 and 5 are diagrams for describing the image encoding process of this embodiment. Here, it is assumed that the pixel-value-to-be-processed input section 101 successively receives pixel data having a fixed bit width (N bits). It is also assumed that the data amount of pixel data received by the pixel-value-to-be-processed input section 101 is eight bits (N=8), i.e., the dynamic range of pixel data is eight bits. It is also assumed that the bit width M of encoded data is five bits.

FIG. 4 shows, as an example, 11 portions of pixel data input to the pixel-value-to-be-processed input section 101. It is assumed that 8-bit pixel data of pixels P1, P2, . . . , and P11 are input, in this stated order, to the pixel-value-to-be-processed input section 101. Numerical values indicated in the pixels P1-P11 are signal levels indicated by the respective corresponding portions of pixel data. Note that it is assumed that pixel data corresponding to the pixel P1 is initial pixel value data.

In this embodiment, it is, for example, assumed that the predicted value of a pixel to be encoded is calculated by prediction expression (1). In this case, the calculated predicted value of a pixel to be encoded is equal to the value of a pixel left-adjacent to the pixel to be encoded. In other words, it is predicted that the pixel value of a pixel to be encoded is highly likely to be equal to the pixel value (level) of a pixel input immediately before the pixel to be encoded.

FIG. 5 shows a relationship between a predicted value (P1) which is obtained when the pixel P2 is input to the pixel-value-to-be-processed input section 101, the results of calculation of the encoded predicted value, the first offset value, the second offset value, and the value to be quantized, and the signal level of the encoded pixel data transmitted to the output section 109.

In the image encoder 100 of FIG. 1, initially, the process of step S101 is performed. In step S101, the pixel-value-to-be-processed input section 101 determines whether or not input pixel data is initial pixel value data. If the determination in step S101 is positive (YES), the pixel-value-to-be-processed input section 101 stores the received pixel data into the internal buffer, and transmits the pixel data to the output section 109. Thereafter, control proceeds to step S110, which will be described later. On the other hand, if the determination in step S101 is negative (NO), control proceeds to step S102.

Here, it is assumed that the pixel-value-to-be-processed input section 101 receives pixel data (initial pixel value data) corresponding to the pixel P1. In this case, the pixel-value-to-be-processed input section 101 stores the input pixel data into the internal buffer, and transmits the pixel data to the output section 109. Note that when pixel data has already been stored in the buffer, the pixel-value-to-be-processed input section 101 overwrites the received pixel data into the internal buffer.

Here, it is assumed that the pixel P2 is a pixel to be encoded. In this case, it is assumed that the pixel-value-to-be-processed input section 101 receives pixel data (pixel data to be encoded) corresponding to the pixel P2. It is also assumed that a pixel value indicated by the pixel data to be encoded is “228.” In this case, because the received pixel data is not initial pixel value data (NO in S101), the pixel-value-to-be-processed input section 101 transmits the received pixel data to the difference generator 103.

When the determination in step S101 is negative (NO), the pixel-value-to-be-processed input section 101 transmits pixel data stored in the internal buffer to the predicted pixel generator 102. Here, it is assumed that the transmitted pixel data indicates the pixel value “180” of the pixel P1.

The pixel-value-to-be-processed input section 101 also overwrites the received pixel data into the internal buffer. The pixel-value-to-be-processed input section 101 also transmits the received pixel data (pixel data to be encoded) to the difference generator 103. Thereafter, control proceeds to step S102.

In step S102, the predicted pixel generator 102 calculates a predicted value of the pixel to be encoded. Specifically, the predicted pixel generator 102 calculates the predicted value using prediction expression (1). In this case, the predicted pixel generator 102 calculates the predicted value to be the pixel value (“180”) indicated by pixel data received from the pixel-value-to-be-processed input section 101. The predicted pixel generator 102 transmits the calculated predicted value “180” to the difference generator 103.

Note that when a predicted value of the h-th pixel to be encoded is calculated, then if the (h−1)th pixel data is initial pixel value data, a value indicated by the (h−1)th pixel data received from the pixel-value-to-be-processed input section 101 is set to be the predicted value as described above, or then if the (h−1)th pixel data is not initial pixel value data, a pixel value indicated by pixel data which is obtained by inputting the (h−1)th data encoded by the image encoder 100 to the image decoder and then decoding the (h−1)th data, may be set to be the predicted value of the pixel to be encoded. As a result, even when an error occurs due to the quantization process performed by the quantizer 106, the same predicted value can be used in the image encoder 100 and the image decoder, whereby a degradation in image quality can be reduced or prevented.

In step S103, an encoded predicted value is calculated. Here, as described above, the encoded predicted value decider 104 calculates the encoded predicted value L represented by M bits based on the signal level of the predicted value represented by N bits received from the predicted pixel generator 102. For example, the encoded predicted value L is calculated by the following expression (10) having characteristics shown in FIG. 6.

L=(predicted value/(2̂(N−M+1))+2̂M/4 (10)

Expression (10) is used to calculate the signal level of a predicted value represented by N bits as it will be encoded into M bits. The calculation technique is not limited to expression (10). A table for converting a signal represented by N bits into M bits may be stored in the internal memory and used for the calculation.

Here, because the predicted value received by the predicted pixel generator 102 is “180,” the encoded predicted value L is calculated to be “19” based on expression (10).

In step S104, a prediction difference value generation process is performed. Specifically, the difference generator 103 subtracts the received predicted value “180” from the pixel value (“228”) indicated by the received pixel data to be encoded, to calculate the prediction difference value to be “48.” The difference generator 103 also transmits the calculated prediction difference value “48” to the quantization width decider 105 and the value-to-be-quantized generator 108. The difference generator 103 also transmits information s indicating the sign (plus or minus) of the result of the subtraction to the value-to-be-quantized generator 108.

In step S105, a quantization width decision process is performed. In the quantization width decision process, the quantization width decider 105 calculates the absolute value (prediction difference absolute value) of the prediction difference value to decide the quantization width Q. Here, it is assumed that the prediction difference absolute value is “48.” In this case, the number of digits (unsigned prediction difference binary digit number) d of binary data which is a binary representation of the prediction difference absolute value is calculated to be “6.” Thereafter, the quantization width decider 105 uses the non-quantization range NQ stored in the internal memory and the unsigned prediction difference binary digit number d to decide the quantization width Q (Q=d−NQ, where Q is a non-negative value). Assuming that the predetermined non-quantization range NQ is “2,” the quantization width Q is calculated as Q=6−2=“4” based on expression (8).

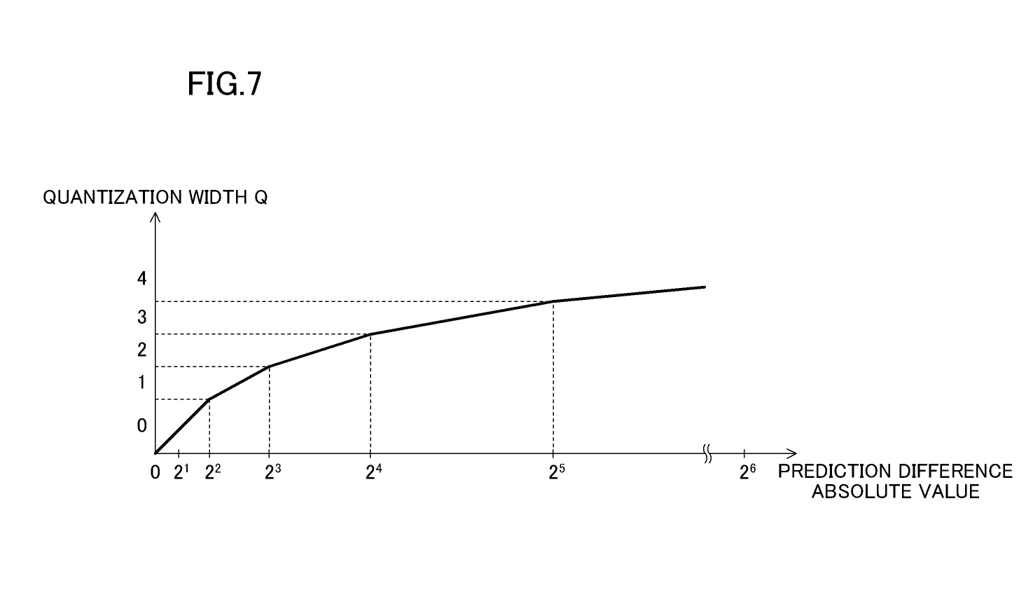

As described above, the quantization width decider 105 sets the quantization width Q to increase as the signal level of the pixel to be encoded progresses away from the predicted value. Therefore, the quantization width Q calculated based on expression (8) has characteristics shown in FIG. 7. That is, as the prediction value absolute value decreases, the quantization width Q decreases, and as the unsigned prediction difference binary digit number d increases, the quantization width Q also increases.

Also, in the quantization width decider 105, by previously deciding a maximum quantization width Q_MAX, the quantization width Q calculated based on expression (8) can be controlled not to exceed Q_MAX, thereby reducing or preventing the occurrence of an error due to quantization (hereinafter referred to as a quantization error). In FIG. 4, by setting Q_MAX to “4,” the quantization widths Q of the pixels P6 and P9 are Q_MAX (“4”), and therefore, even if the prediction difference absolute value is great, the quantization error can be limited to a maximum of 15.

In step S106, the first and second offset values are calculated. The value-to-be-quantized generator 108 calculates the first offset value based on 2̂(d−1) when the unsigned prediction difference binary digit number of the prediction difference value received from the difference generator 103 is d. Here, it is assumed that the unsigned prediction difference binary digit number of the prediction difference value received from the difference generator 103 is “6.” In this case, the value-to-be-quantized generator 108 calculates the first offset value to be “32” based on 2̂(d−1).

In a second offset value calculation process, the offset value generator 107 calculates the second offset value F based on the quantization width Q received from the quantization width decider 105 using expression (9). Here, it is assumed that the quantization width Q received from the quantization width decider 105 is “4.” In this case, the offset value generator 107 calculates the second offset value F to be “10” based on expression (9).

In this case, the second offset value F represents the level of the first offset value, where a pixel to be encoded represented by N bits is encoded to generate encoded pixel data represented by M bits as shown in FIG. 5. Therefore, as the unsigned prediction difference binary digit number d of the prediction difference value calculated by the difference generator 103 increases, both the first and second offset values increase.

Note that when the quantization width Q received from the quantization width decider 105 is “0,” the value-to-be-quantized generator 108 sets the first offset value to “0,” and the offset value generator 107 sets the second offset value to “0,” whereby the prediction difference value can be transmitted, without modification, to the adder 111.

In step S107, a value-to-be-quantized generation process is performed. In the value-to-be-quantized generation process, the value-to-be-quantized generator 108 subtracts the first offset value from the prediction difference absolute value received from the difference generator 103, to generate a value to be quantized. Here, it is assumed that the prediction difference absolute value received from the difference generator 103 is “48,” and the first offset value calculated by the value-to-be-quantized generator 108 is “32.” In this case, in step S107, the value-to-be-quantized generator 108 subtracts the first offset value from the prediction difference absolute value to calculate the value to be quantized to be “16,” and outputs, to the quantizer 106, the value to be quantized together with the information s indicating the sign of the prediction difference value received from the difference generator 103.

In step S108, a quantization process is performed. In the quantization process, the quantizer 106 receives the quantization width Q calculated by the quantization width decider 105, and divides the value to be quantized received from the value-to-be-quantized generator 108 by 2 raised to the power of Q. Here, it is assumed that the quantization width Q which the quantizer 106 receives from the quantization width decider 105 is “4,” and the value to be quantized which the quantizer 106 receives from the value-to-be-quantized generator 108 is “16.” In this case, the quantizer 106 performs the quantization process by dividing “16” by 2 raised to the power of 4 to obtain “1,” and outputs, to the adder 110, the value “1” together with the sign information s received from the value-to-be-quantized generator 108.

In step S109, an encoding process is performed. In the encoding process, initially, the adder 110 adds the quantization result received from the quantizer 106 and the second offset value F received from the offset value generator 107 together, and adds the sign information s received from the quantizer 106 to the result of that addition. Here, it is assumed that the quantization result from the quantizer 106 is “1,” the sign information s is “plus,” and the second offset value F received from the offset value generator 107 is “10.” In this case, the quantized pixel data “11” obtained by the adder 110 is transmitted to the adder 111.

Here, when the sign information s received from the quantizer 106 is “minus,” the sign information s is added to the quantized pixel data, which is then transmitted as a negative value to the adder 111.

The adder 111 adds the quantized pixel data received from the adder 110 and the encoded predicted value L received from the encoded predicted value decider 104 together to obtain 5-bit encoded pixel data as shown in FIG. 5, and outputs the encoded pixel data to the output section 109. Here, it is assumed that the encoded predicted value L received from the encoded predicted value decider 104 is “19.” In this case, the adder 111 adds the encoded predicted value L and the quantized pixel data (“11”) together to generate “30,” which is encoded pixel data represented by M bits.

When the quantized pixel data received from the adder 110 is negative, i.e., the prediction difference value is negative, the absolute value of the quantized pixel data is subtracted from the encoded predicted value L. By this process, when the prediction difference value is negative, the value of the encoded pixel data is smaller than the encoded predicted value L, and therefore, information indicating that the pixel to be encoded has a value smaller than the predicted value is included into the encoded pixel data, which is then transmitted.

Thereafter, in step S110, the encoded pixel data generated by the adder 111 is transmitted from the output section 109.

In step S111, it is determined whether or not the encoded pixel data transmitted from the output section 109 is the last one for one image, i.e., whether or not the encoding process has been completed for one image. If the determination in S111 is positive (YES), the encoding process is ended. If the determination in S111 is negative (NO), control proceeds to step S101, and at least one of steps S101-S111 is performed.

The results of the above processes and calculations, i.e., the calculated prediction difference values, prediction difference absolute values, quantization widths, first offset values, and second offset values of the pixels to be encoded P2-P11, and the 5-bit encoded pixel data of the pixels output from the output section 109, are shown in FIG. 4.

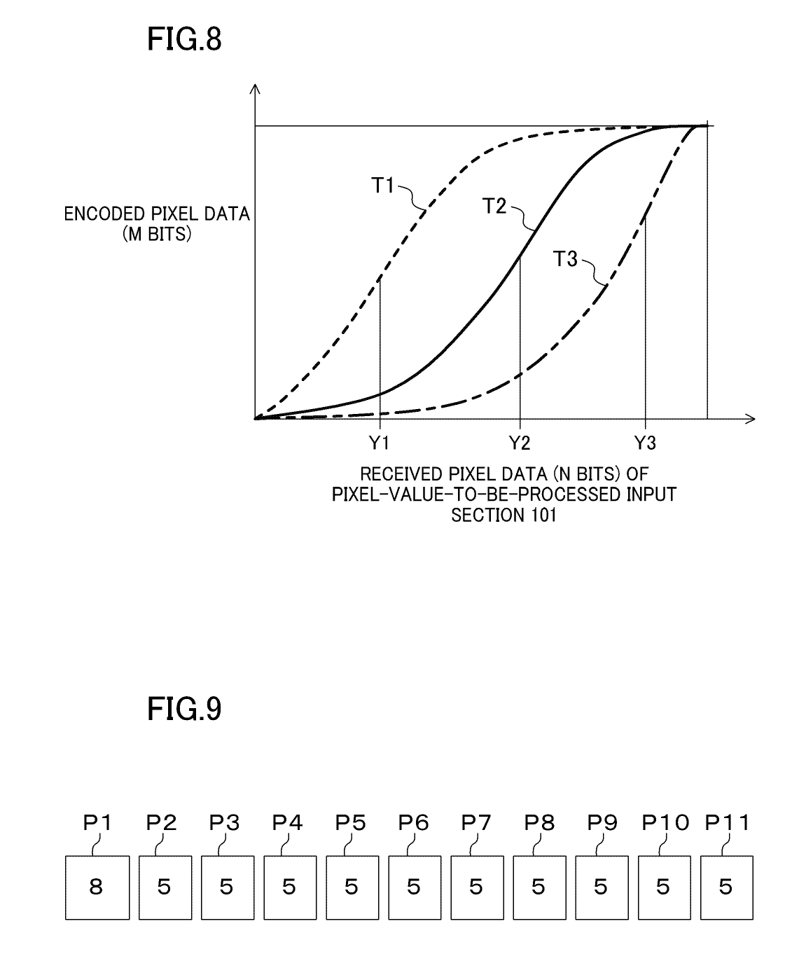

In the above encoding process performed by the image encoder 100, a relationship between the N-bit pixel data input from the pixel-value-to-be-processed input section 101, the predicted value calculated based on the value of the N-bit pixel data by the predicted pixel generator 102, and the M-bit encoded pixel data output by the output section 109, is shown in FIG. 8.

FIG. 8 shows a relationship between the value of a pixel to be encoded received by the pixel-value-to-be-processed input section 101, and encoded pixel data represented by M bits which is output from the output section 109 when the pixel to be encoded is encoded, using a nonlinear curved line T1, where the predicted value represented by N bits has a value of Y1 in this embodiment. Similarly, a case where the predicted value has a value of Y2 is indicated by a nonlinear curved line T2, and a case where the predicted value has a value of Y3 is indicated by a nonlinear curved line T3.

In this embodiment, the level of the encoded predicted value L corresponding to the signal level of the predicted value is calculated using expression (10), and characteristics as shown in FIG. 7 are imparted to the quantization width Q. As a result, the relationship between the value of a pixel to be encoded and encoded pixel data thereof is that, as shown in FIG. 8, values in the vicinity of the predicted value are not compressed to a large extent, the compression ratio increases as the value progresses away from the predicted value, and the characteristics of a nonlinear curved line indicating the relationship between the value of the pixel to be encoded and the encoded pixel data thereof is adaptively changed, depending on the signal level of the predicted value.

Note that, in this embodiment, as shown in FIG. 5, the compression process from N bits into M bits is achieved by calculating two parameters, i.e., the first and second offset values, and performing the quantization process in the quantizer 106. However, a table may be previously produced which indicates a relationship between prediction difference absolute values represented by N bits and quantized pixel data represented by M bits, and stored in the internal memory, and the prediction difference absolute values may be compressed by referencing the values of the table, whereby the above process can be removed. In this case, as the value of N indicting the bit length of a pixel to be encoded increases, a memory device having a larger capacity for storing the table is required. Nevertheless, the quantization width decider 105, the quantizer 106, the offset value generator 107, the value-to-be-quantized generator 108, and the adder 110 are no longer required, and steps S105, S106, S107, and S108 of the encoding process can be removed.

Also, in this embodiment, as shown in FIG. 9, portions of encoded pixel data represented by a plurality of fixed bit widths are successively stored from the output section 109 into an external memory device. FIG. 9 is a diagram showing initial pixel value data and encoded pixel data which are output from the image encoder 100 when the processes and calculations described in FIG. 4 are performed. In FIG. 9, numerical values shown in the pixels P1-P11 each indicate the number of bits of corresponding pixel data. As shown in FIG. 9, the pixel value of the pixel P1 corresponding to initial pixel value data is represented by 8-bit data, and the encoded pixel data of the other pixels P2-P11 is represented by 5 bits. In other words, stored pixel data is limited to 8-bit initial pixel value data or 5-bit encoded data, and there is no bit other than pixel data including quantization information etc.

Also, by setting the bit length of packed data including at least one portion of initial pixel value data and at least one portion of encoded pixel data to be equal to the bus width of data transfer in an integrated circuit, it can be guaranteed that the bus width has a fixed length. Therefore, when there is a request for data access to predetermined encoded pixel data, it is only necessary to access packed data including encoded pixel data which is packed on a bus width-by-bus width basis. In this case, when the bus width is not equal to the bit length of packed data, and therefore, there is an unused bit(s), the unused bit may be replaced with dummy data. Because data within the bus width includes only initial pixel value data and encoded pixel data and does not include a bit indicating quantization information etc., efficient compression can be achieved, and packing/unpacking can also be easily achieved.

As described above, according to this embodiment, a quantization width can be decided on a pixel-by-pixel basis while the random access ability is maintained, whereby a degradation in the image quality of an image can be reduced.

Note that the image encoding process of this embodiment may be implemented by hardware, such as a large scale integration (LSI) circuit etc. All or a part of a plurality of parts included in the image encoder 100 may be implemented as program modules which are performed by a central processing unit (CPU) etc.

The dynamic range (M bits) of encoded data may be changed, depending on the capacity of a memory device for storing the encoded data.

<Decoding Process Performed by Image Decoder 200>

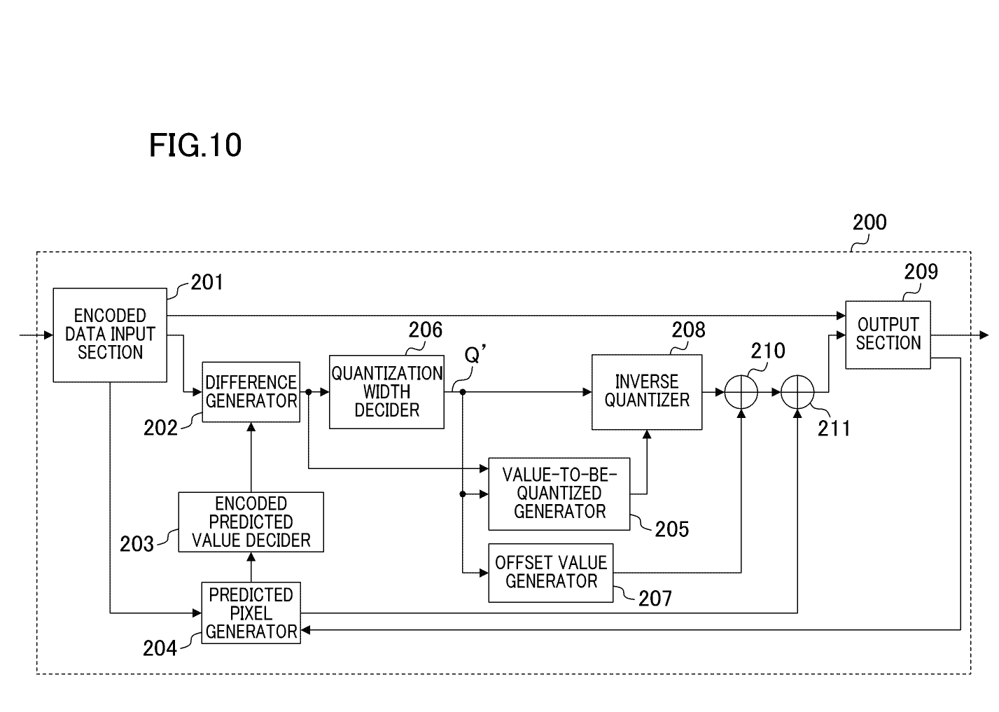

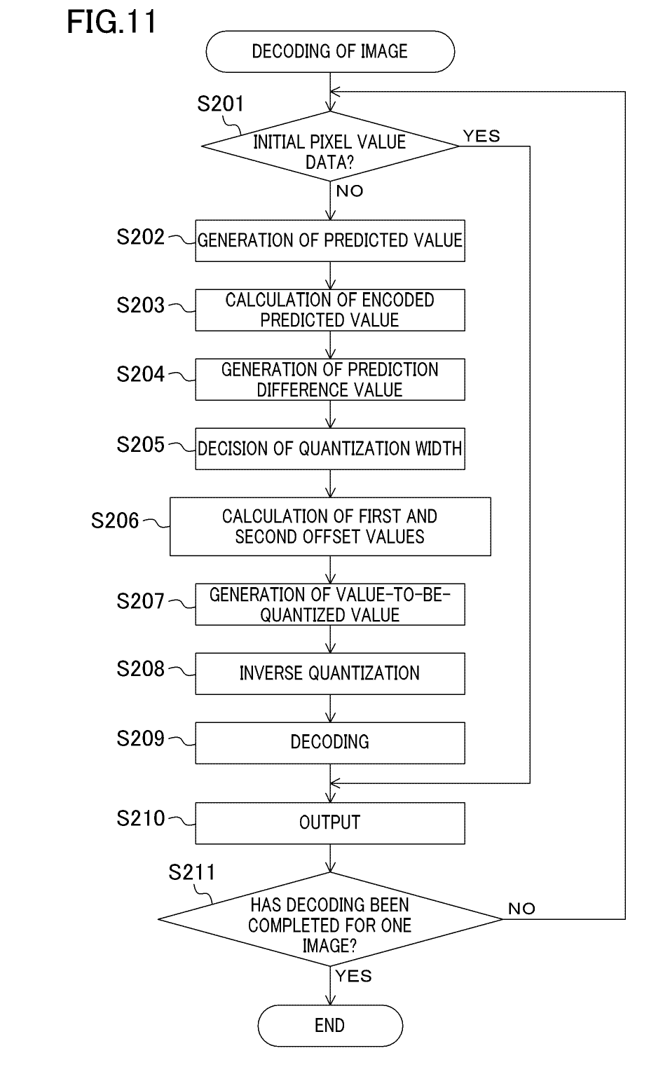

FIG. 10 is a block diagram showing a configuration of an image decoder 200 according to the first embodiment of the present disclosure. FIG. 11 is a flowchart of an image decoding process. A process of decoding encoded data which is performed by the image decoder 200 will be described with reference to FIGS. 10 and 11.

For example, the 1st to 11th portions of pixel data input to the encoded data input section 201 are 11 portions of pixel data corresponding to the pixels P1-P11 of FIG. 9, respectively. The 11 portions of pixel data are initial pixel value data having a length of N bits or pixels to be decoded having a length of M bits (hereinafter referred to as pixels to be decoded).

Encoded data input to the encoded data input section 201 is transmitted to a difference generator 202 with appropriate timing. Note that when encoded data of interest is input as initial pixel value (YES in step S201 of FIG. 11), the encoded data is transmitted without an inverse quantization process, i.e., directly, to a predicted pixel generator 204 and an output section 209. When the encoded data of interest is not an initial pixel value (NO in step S201 of FIG. 11), control proceeds to a predicted pixel generation process (step S202 in FIG. 11).

Pixel data input to the predicted pixel generator 204 is either initial pixel value data which has been input before a pixel to be decoded of interest or pixel data (hereinafter referred to as decoded pixel data) which has been decoded and output from the output section 209 before the pixel to be decoded of interest. The input pixel data is used to generate a predicted value represented by N bits. The predicted value is generated using a prediction expression similar to that which is used in the predicted pixel generator 102 of the image encoder 100, i.e., any of the aforementioned prediction expressions (1)-(7). The calculated predicted value is output to an encoded predicted value decider 203 (step S202 of FIG. 11).

The encoded predicted value decider 203 calculates the bit length of encoded data after encoding, i.e., an encoded predicted value L which is a signal level of a predicted value represented by M bits, based on a signal level of a predicted value represented by N bits which has been received from the predicted pixel generator 204. Therefore, the encoded predicted value L indicates the signal level of a predicted value represented by N bits as it will be encoded into M bits, and the same expression as that of the encoded predicted value decider 104 of the image encoder 100 is used as in the predicted pixel generator 204 (step S203 of FIG. 11).

The difference generator 202 generates a difference (hereinafter referred to as a prediction difference value) between the pixel to be decoded received from the encoded data input section 201 and the encoded predicted value L received from the encoded predicted value decider 203. The generated prediction difference value is transferred to a quantization width decider 206 (step S204 of FIG. 11).

The quantization width decider 206 decides a quantization width Q′ which is used in an inverse quantization process, based on the prediction difference value corresponding to each pixel to be decoded, which has been received from the difference generator 202, and outputs the decided quantization width Q′ to an inverse quantizer 208, a value-to-be-quantized generator 205, and an offset value generator 207.

The quantization width Q′ used in the inverse quantization process can be obtained by subtracting a range “2 raised to the power of NQ” of prediction difference values which are not to be quantized, where NQ is the non-quantization range used in the image encoder 100, from the absolute value of the prediction difference value (hereinafter referred to as a prediction difference absolute value), dividing the resultant value by a non-quantization range “2 raised to the power of NQ/2”, and adding 1 to the resultant value (step S205 of FIG. 11). In other words, the quantization width Q′ used in the inverse quantization process is calculated by:

Q′=(prediction difference absolute value−2̂NQ)/(2̂(NQ−1))+1 (11)

Here, it is assumed that the non-quantization range NQ has the same value as that which is used in the image encoder 100, and is stored in an internal memory of the image decoder 200.

The value-to-be-quantized generator 205 calculates a signal level of encoded data which is to be inverse-quantized, i.e., a value to be quantized, based on the quantization width Q′ received from the quantization width decider 206. The value to be quantized is obtained by subtracting a first offset value calculated by the value-to-be-quantized generator 205 from the prediction difference absolute value. The first offset value is, for example, calculated by expression (9). Specifically, the first offset value calculated by the value-to-be-quantized generator 205 has the same meaning as that of the second offset value calculated in step S106 of the image encoding process performed by the image encoder 100, and NQ is the same non-quantization range as that of the predetermined values used in the image encoder 100. Therefore, the first offset value also varies depending on the quantization width Q′ received from the quantization width decider 206. The value-to-be-quantized generator 205 transmits the calculated value to be quantized to the inverse quantizer 208 (steps S206 and S207 of FIG. 11).

The offset value generator 207 calculates a second offset value F′ based on the quantization width Q′ received from the quantization width decider 206 (step S206 of FIG. 11). The second offset value F′ is, for example, calculated by:

F′=2̂(Q′+NQ−1) (12)

The second offset value F′ calculated by expression (12) has the same meaning as that of the first offset value calculated in step S106 of the image encoding process of the image encoder 100.

The inverse quantizer 208 performs an inverse quantization process to inverse-quantize the value to be quantized received from the value-to-be-quantized generator 205 based on the quantization width Q′ for inverse quantization calculated by the quantization width decider 206. Note that the inverse quantization process performed based on the quantization width Q′ is a process of multiplying a value to be quantized corresponding to a pixel to be decoded by two raised to the power of Q′. Note that when the quantization width Q′ is “0,” the inverse quantizer 208 does not perform inverse quantization (step S208 of FIG. 11).

The result of the inverse quantization output from the inverse quantizer 208 and the second offset value F′ output from the offset value generator 207 are added together by an adder 210. Thereafter, pixel data (hereinafter referred to as inverse-quantized pixel data) output from the adder 210 and the predicted value received from the predicted pixel generator 204 are added together by an adder 211 to generate pixel data (hereinafter referred to as decoded pixel data) represented by N bits (step S209 of FIG. 11). The decoded pixel data generated by the adder 211 is transmitted from the output section 209 (step S210 of FIG. 11).

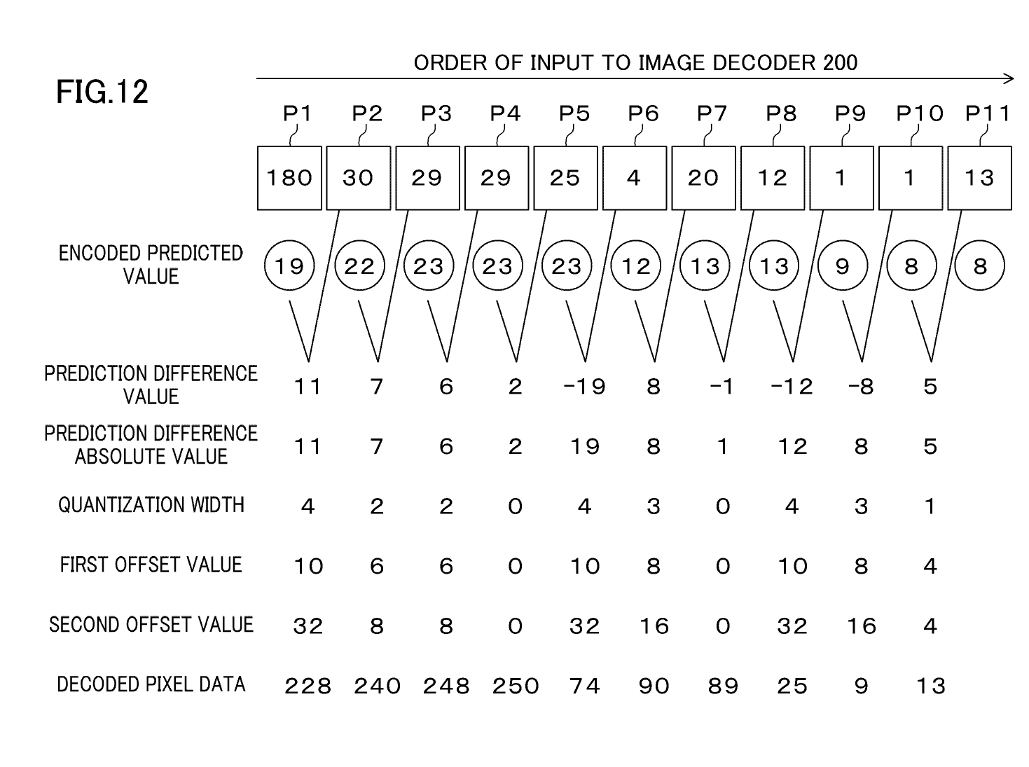

FIG. 12 is a diagram for describing the image decoding process of this embodiment. Here, it is assumed that the encoded data input section 201 successively receives 8-bit initial pixel data (N=8) or 5-bit pixel data to be decoded (M=5). FIG. 12 shows, as an example, the result of the image encoding process performed on the 11 portions of pixel data shown in FIG. 4, as inputs to the image decoder 200. It is assumed that, as shown in FIG. 9, a plurality of portions of encoded data stored in an external memory device are input to the encoded data input section 201 in order of pixel, i.e., P1, P2, and, P11. Numerical values shown in the pixels P1-P11 of FIG. 12 each indicate a signal level indicated by the corresponding pixel data. Pixel data corresponding to the pixel P1 is initial pixel value and therefore represented by 8 bits, and P2-P11 are pixel data to be decoded and therefore represented by 5 bits.

In the image decoding process, initially, step S201 is performed. In step S201, the encoded data input section 201 determines whether or not input pixel data is initial pixel value data. If the determination in step S201 is positive (YES), the encoded data input section 201 stores the received pixel data into an internal buffer, and outputs the pixel data to the output section 209. Thereafter, control proceeds to step S210, which will be described later. On the other hand, if the determination in step S201 is negative (NO), control proceeds to step S202.

Here, it is assumed that the encoded data input section 201 receives pixel data which is initial pixel value data corresponding to the pixel P1. In this case, the encoded data input section 201 stores the received pixel data into the internal buffer, and transmits the pixel data to the output section 209. Note that when pixel data is already stored in the internal buffer, the encoded data input section 201 overwrites the received pixel data into the internal buffer.

Here, it is assumed that the pixel P2 is pixel data to be decoded. It is also assumed that a pixel value indicated by the pixel data to be decoded is “30.” In this case, because the received pixel data is not initial pixel value data (NO in S201), the encoded data input section 201 transmits the received pixel data to the difference generator 202.

When a predicted value is calculated for the h-th (h is an integer of two or more) pixel to be encoded, then if the determination in step S201 is negative (NO) and the (h−1)th pixel data is initial pixel value data, the encoded data input section 201 transmits pixel data stored in the internal buffer to the predicted pixel generator 204. Here, it is assumed that the transmitted pixel data indicates the pixel value of the pixel P1, i.e., “180.” A process performed when the (h−1)th pixel data is not initial pixel value data will be described later. The encoded data input section 201 also transmits the received pixel data to be decoded to the difference generator 202. Thereafter, control proceeds to step S202.

In step S202, the predicted pixel generator 204 calculates a predicted value for the pixel to be decoded. Specifically, the predicted pixel generator 204 uses the same prediction technique as that of step S102 (predicted pixel generation process) of the image encoding process of the image encoder 100, to calculate the predicted value using prediction expression (1). In this case, the predicted pixel generator 204 calculates the predicted value to be the pixel value (“180”) indicated by the pixel data received from the encoded data input section 201. The predicted pixel generator 204 transmits the calculated predicted value “180” to the encoded predicted value decider 203.

In step S203, an encoded predicted value is calculated. Here, as described above, the encoded predicted value decider 203 calculates an encoded predicted value L represented by M bits, based on the signal level of the predicted value represented by N bits which has been received from the predicted pixel generator 204. In this case, because the encoded predicted value L is the same as that which is obtained by step S103 (encoded predicted value calculation process) of the image encoding process of the image encoder 100, the predicted pixel generator 204 calculates the encoded predicted value L using expression (10). Here, it is intended to calculate a value represented by the same M bits as those of the value calculated in step S103, based on the signal level of a predicted value represented by N bits. The present disclosure is not necessarily limited to expression (10). A table for converting a signal represented by N bits into M bits may be stored in the internal memory of the image decoder 200 and used for the calculation.

Here, because the predicted value received by the predicted pixel generator 204 is “180,” the encoded predicted value is calculated to be “19” based on expression (10).

In step S204, a prediction difference value generation process is performed. Specifically, the difference generator 202 subtracts the received predicted value “19” from the pixel value (“30”) indicated by the received pixel data to be encoded, to calculate a prediction difference value “11.” The difference generator 202 also transmits the calculated prediction difference value “11,” and information s obtained as a result of the subtraction, to the quantization width decider 206.

In step S205, a quantization width decision process is performed. In the quantization width decision process, the quantization width decider 206 calculates a prediction difference absolute value to decide the quantization width Q′ for the inverse quantization process. Here, it is assumed that the prediction difference absolute value is “11.” In this case, if it is assumed that the predetermined non-quantization range NQ is “2,” Q′=(11−2̂2)/2+1 based on expression (11), i.e., the quantization width Q′ for the inverse quantization process is set to “4.” The quantization width decider 206 transmits the quantization width Q′ to the value-to-be-quantized generator 205, the offset value generator 207, and the inverse quantizer 208. The quantization width decider 206 also transmits the sign information s of the prediction difference value received from the difference generator 202, to the value-to-be-quantized generator 205.

The quantization width Q calculated using expression (8) in the quantization width decider 105 of the image encoder 100, has characteristics that the quantization width Q increases by one every time the value obtained by subtracting “2 raised to the power of NQ” from the prediction difference absolute value is increased by “(2 raised to the power of NQ)/2.” Therefore, in the image decoder 200, the quantization width Q′ for the inverse quantization process is calculated using expression (11). Note that the expression for calculating the quantization width Q′ for the inverse quantization process in the quantization width decision process of step S205 may vary depending on a technique used for the quantization width decision process of step S105.

In step S206, a first offset value and a second offset value are calculated. The first offset value is calculated by the value-to-be-quantized generator 205 receiving the quantization width Q′ from the quantization width decider 206 and then substituting the value of Q′ into “Q” in expression (9). Here, it is assumed that the quantization width Q′ received from the quantization width decider 206 is “4.” The value-to-be-quantized generator 205 calculates the first offset value to be “10.”

The second offset value F′ is calculated by the offset value generator 207 based on the quantization width Q′ received from the quantization width decider 206, using expression (12). Here, it is assumed that the quantization width Q′ received from the quantization width decider 206 is “4.” The offset value generator 207 calculates the second offset value F′ using expression (12) to be “32.”

In this case, the second offset value F′ represents the level of the first offset value, where a pixel to be decoded represented by M bits is decoded to generate decoded pixel data represented by N bits. Therefore, as the quantization width Q′ calculated by the quantization width decider 206 increases, both the first and second offset values increase.

Note that when the quantization width Q′ received from the quantization width decider 206 is “0,” the value-to-be-quantized generator 205 sets the first offset value to “0,” and the offset value generator 207 sets the second offset value to “0,” whereby the prediction difference value can be transmitted, without modification, to the adder 211.

In step S207, a value-to-be-quantized generation process is performed. In the value-to-be-quantized generation process, the value-to-be-quantized generator 205 subtracts the first offset value from the prediction difference value received from the difference generator 202, to generate a value to be quantized. Here, it is assumed that the prediction difference value received from the difference generator 202 is “11,” and the first offset value calculated by the value-to-be-quantized generator 205 is “10.” In this case, in step S207, the value-to-be-quantized generator 205 subtracts the first offset value from the prediction difference value to calculate the value to be quantized to be “1,” and outputs, to the inverse quantizer 208, the value to be quantized together with the information s of the prediction difference value received from the quantization width decider 206.

In step S208, an inverse quantization process is performed. In the inverse quantization process, the inverse quantizer 208 receives the quantization width Q′ for inverse quantization calculated by the quantization width decider 206, and multiplies the value to be quantized received from the value-to-be-quantized generator 205 by two raised to the power of Q′. Here, it is assumed that the quantization width Q′ received by the inverse quantizer 208 from the quantization width decider 206 is “4,” and the value to be quantized received by the inverse quantizer 208 from the value-to-be-quantized generator 205 is “1.” In this case, the inverse quantizer 208 performs the inverse quantization process by multiplying “1” by 2 raised to the power of 4 to obtain “16,” and outputs, to the adder 210, the value “16” together with the sign information s of the difference value received from the value-to-be-quantized generator 205.

In step S209, a decoding process is performed. In the decoding process, initially, the adder 210 adds the inverse quantization result received from the inverse quantizer 208 and the second offset value F′ received from the offset value generator 207 together, and adds the sign information s received from the inverse quantizer 208 to the result of that addition. Here, it is assumed that the inverse quantization result from the inverse quantizer 208 is “16,” the sign information s is “plus,” and the second offset value F′ received from the offset value generator 207 is “32.” In this case, the inverse-quantized pixel data “48” obtained by the adder 210 is transmitted to the adder 211. Here, if the sign information s received from the inverse quantizer 208 is “minus,” the sign information s may be added to the inverse-quantized pixel data, which is then transmitted as a negative value to the adder 211.

The adder 211 adds the inverse-quantized pixel data received from the adder 210 and the predicted value received from the predicted value decider 204 together to obtain decoded pixel data. Here, it is assumed that the predicted value received from the predicted value decider 204 is “180.” In this case, the adder 211 adds the predicted value and the inverse-quantized pixel data (“48”) together to generate “228” which is decoded pixel data represented by N bits. When the inverse-quantized pixel data received from the adder 210 is negative, i.e., the prediction difference value is negative, the inverse-quantized pixel data is subtracted from the predicted value. By this process, the decoded pixel data has a smaller value than that of the predicted value. Therefore, the relative order of magnitude of the pixel data before the image encoding process received by the pixel-value-to-be-processed input section 101, and the predicted value thereof, can be maintained by comparing the pixel to be decoded and the encoded predicted value.

Thereafter, in step S210, the decoded pixel data generated by the adder 211 is transmitted by the output section 209. The output section 209 stores the decoded pixel data received from the adder 211, into an external memory device and the predicted pixel generator 204. Alternatively, the output section 209 may output the decoded pixel data to an external circuit etc. for performing image processing, instead of storing the decoded pixel data into an external memory device.

Finally, in step S211, it is determined whether or not the decoded pixel data transmitted from the output section 209 is the last one for one image, i.e., whether or not the decoding process has been completed for one image. If the determination in S211 is positive (YES), the decoding process is ended. If the determination in S211 is negative (NO), control proceeds to step S201, and at least one of steps S201-S211 is performed.

Here, it is assumed that the pixel P3 of FIG. 12 is pixel data to be decoded. It is also assumed that a pixel value indicated by the pixel data to be decoded is “29.” In this case, because the received pixel data is not initial pixel value data (NO in S201), the encoded data input section 201 transmits the received pixel data to the difference generator 202. Thereafter, control proceeds to step S202.

In step S202, when a predicted value for the h-th pixel to be encoded is calculated, then if the (h−1)th pixel data is not initial pixel value data, the predicted value cannot be calculated using prediction expression (1). Therefore, if the determination in step S201 is negative (NO), and the (h−1)th pixel data is not initial pixel value data, the predicted pixel generator 204 sets the (h−1)th decoded pixel data received from the output section 209 to be the predicted value.

In this case, the (h−1)th decoded pixel data, i.e., the decoded pixel data “228” of the pixel P2, is calculated to be the predicted value, which is then transmitted to the encoded predicted value decider 203. Thereafter, control proceeds to step S203.

Thereafter, a process similar to that for the pixel P2 is also performed on the pixel P3 to generate decoded pixel data.

The encoded predicted values, prediction difference values, prediction difference absolute values, quantization widths, first offset values, and second offset values of the pixels to be decoded P2-P11 which are calculated as a result of execution of the above processes and calculations, and decoded pixel data corresponding to the pixels represented by eight bits, which are output from the output section 209, are shown in FIG. 12. Note that, here, it is also assumed that the greatest value of the quantization width Q′ is “4.”

Note that a slight error occurs between the 11 portions of pixel data input to the pixel-value-to-be-processed input section 101 shown in FIG. 4 and the 11 portions of decoded pixel data shown in FIG. 12. This is because of an error which is removed when the quantizer 106 performs division by two raised to the power of Q, i.e., a quantization error and an error in the predicted value itself. The error in the predicted value itself refers to an error which occurs when there is a difference between the result of calculation using pixel data left-adjacent to a pixel to be encoded in the predicted pixel generation process (step S102 of FIG. 2) of the image encoding process of FIG. 4, and the result of calculation using decoded pixel data obtained prior to a pixel to be decoded of interest in the predicted pixel generation process (step S202 of FIG. 11) of the image decoding process of FIG. 12. This leads to a degradation in image quality as in the case of the quantization error. Therefore, as described above, when a predicted value for the h-th pixel to be encoded is calculated, then if the (h−1)th pixel data is initial pixel value data, a value indicated by the (h−1)th pixel data received from the pixel-value-to-be-processed input section 101 is set to be the predicted value, or then if the (h−1)th pixel data is not initial pixel value data, a pixel value indicated by pixel data obtained by inputting (h−1)th data encoded by the image encoder 100 to the image decoder 200 and then decoding the (h−1)th data, may be set to be the predicted value for the pixel to be encoded. As a result, even if a quantization error occurs in the quantizer 106, the image encoder 100 and the image decoder 200 can use the same predicted value, whereby a degradation in image quality can be reduced or prevented.

Note that, in this embodiment, the decoding process from M bits into N bits is achieved by calculating two parameters, i.e., the first and second offset values, and performing the inverse quantization process in the inverse quantizer 208. However, a table may be previously produced which indicates a relationship between prediction difference absolute values represented by M bits and decoded pixel data represented by N bits, and stored in the internal memory of the image decoder 200, and the prediction difference absolute values may be decoded by referencing the values of the table, whereby the above process can be removed. In this case, the quantization width decider 206, the inverse quantizer 208, the offset value generator 207, the value-to-be-quantized generator 205, and the adder 210 are no longer required, and steps S205, S206, S207, and S208 of the decoding process can be removed.

Also, in the image encoding process and the image decoding process of this embodiment, all the parameters are calculated based on the number of digits of the unsigned integer binary representation of the prediction difference value, and the quantization width. The image encoder 100 and the image decoder 200 use similar calculation expressions. Therefore, it is not necessary to transmit bits other than pixel data, such as quantization information etc., resulting in high compression.

Note that the image decoding process of this embodiment may be implemented by hardware, such as an LSI circuit etc. All or a part of a plurality of parts included in the image decoder 200 may be implemented as program modules performed by a CPU etc.

### Second Embodiment

In a second embodiment, an example digital still camera including the image encoder 100 and the image decoder 200 of the first embodiment will be described.

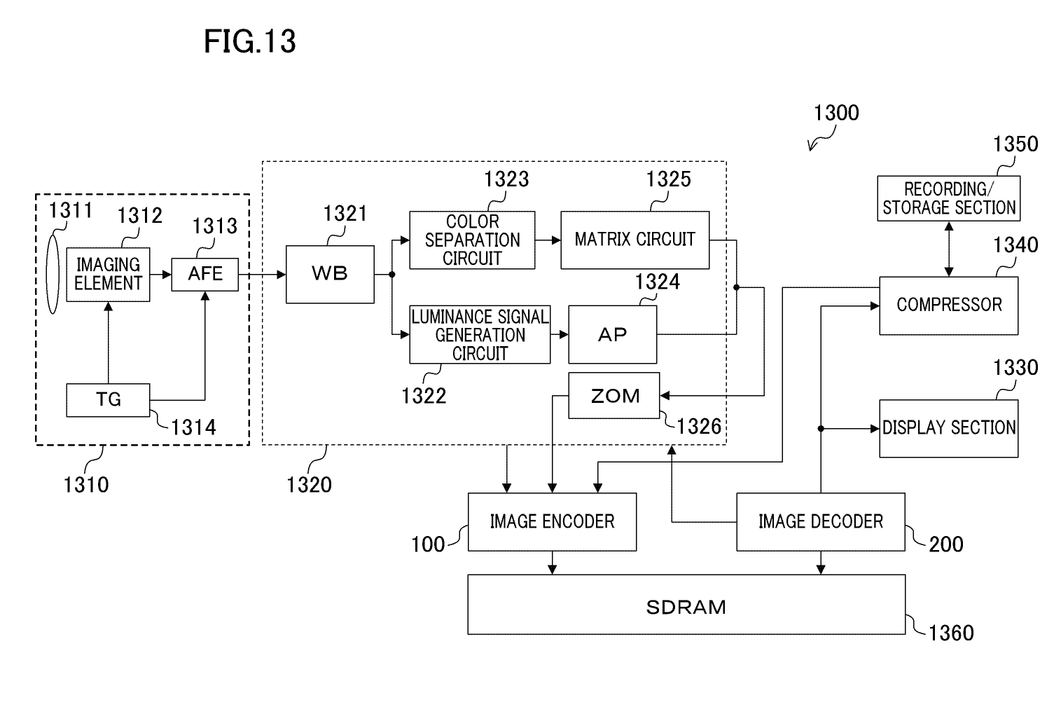

FIG. 13 is a block diagram showing a configuration of a digital still camera 1300 according to the second embodiment. As shown in FIG. 13, the digital still camera 1300 includes the image encoder 100 and the image decoder 200. The configurations and functions of the image encoder 100 and the image decoder 200 have been described above in the first embodiment.

The digital still camera 1300 further includes an imager 1310, an image processor 1320, a display section 1330, a compressor 1340, a recording/storage section 1350, and an SDRAM 1360.

The imager 1310 captures an image of an object, and outputs digital image data corresponding to the image. In this example, the imager 1310 includes an optical system 1311, an imaging element 1312, an analog front end (abbreviated as AFE in FIG. 13) 1313, and a timing generator (abbreviated as TG in FIG. 13) 1314. The optical system 1311, which includes a lens etc., images an object onto the imaging element 1312. The imaging element 1312 converts light incident from the optical system 1311 into an electrical signal. As the imaging element 1312, various imaging elements may be employed, such as an imaging element including a charge coupled device (CCD), an imaging element including a CMOS, etc. The analog front end 1313 performs signal processing, such as noise removal, signal amplification, A/D conversion, etc., on an analog signal output by the imaging element 1312, and outputs the result as image data. The timing generator 1314 supplies, to the imaging element 1312 and the analog front end 1313, a clock signal indicating reference operation timings therefor.

The image processor 1320 performs predetermined image processing on pixel data (RAW data) received from the imager 1310, and outputs the result to the image encoder 100. As shown in FIG. 13, the image processor 1320 typically includes a white balance circuit (abbreviated as WB in FIG. 13) 1321, a luminance signal generation circuit 1322, a color separation circuit 1323, an aperture correction circuit (abbreviated as AP in FIG. 13) 1324, a matrix process circuit 1325, a zoom circuit (abbreviated as ZOM in FIG. 13) 1326 which enlarges and reduces an image, etc. The white balance circuit 1321 is a circuit which corrects the ratio of color components of a color filter in the imaging element 1312 so that a captured image of a white object has a white color under any light source. The luminance signal generation circuit 1322 generates a luminance signal (Y signal) from RAW data. The color separation circuit 1323 generates a color difference signal (Cr/Cb signal) from RAW data. The aperture correction circuit 1324 performs a process of adding a high frequency component to the luminance signal generated by the luminance signal generation circuit 1322 to enhance the apparent resolution. The matrix process circuit 1325 performs, on the output of the color separation circuit 1323, a process of adjusting spectral characteristics of the imaging element 1312 and hue balance impaired by image processing.

Typically, the image processor 1320 temporarily stores pixel data to be processed into a memory device, such as the SDRAM 1360 etc., and performs predetermined image processing, YC signal generation, zooming, etc. on temporarily stored data, and temporarily stores the processed data back into the SDRAM 1360. Therefore, the image processor 1320 is considered to output data to the image encoder 100 and receive data from the image decoder 200.

The display section 1330 displays an output (decoded image data) of the image decoder 200.

The compressor 1340 compresses an output of the image decoder 200 based on a predetermined standard, such as JPEG etc., and outputs the resultant image data to the recording/storage section 1350. The compressor 1340 also decompresses image data read from the recording/storage section 1350, and outputs the resultant image data to the image encoder 100. In other words, the compressor 1340 can process data based on the JPEG standard. The compressor 1340 having such functions is typically included in the digital still camera 1300.

The recording/storage section 1350 receives and records the compressed image data into a recording medium (e.g., a non-volatile memory device etc.). The recording/storage section 1350 also reads out compressed image data recorded in the recording medium, and outputs the compressed image data to the compressor 1340.

Signals input to the image encoder 100 and the image decoder 200 of this embodiment are not limited to RAW data. For example, data to be processed by the image encoder 100 and the image decoder 200 may be, for example, data of a YC signal (a luminance signal or a color difference signal) generated from RAW data by the image processor 1320, or data (data of a luminance signal or a color difference signal) obtained by decompressing data of a JPEG image which has been temporarily compressed based on JPEG etc.

As described above, the digital still camera 1300 of this embodiment includes the image encoder 100 and the image decoder 200 which process RAW data or a YC signal, in addition to the compressor 1340 which is typically included in a digital still camera. As a result, the digital still camera 1300 of this embodiment can perform high-speed shooting operation with an increased number of images having the same resolution which can be shot in a single burst, using the same memory capacity. The digital still camera 1300 can also enhance the resolution of a moving image which is stored into a memory device having the same capacity.

The configuration of the digital still camera 1300 of the second embodiment is also applicable to the configuration of a digital camcorder which includes an imager, an image processor, a display section, a compressor, a recording/storage section, and an SDRAM as in the digital still camera 1300.

### Third Embodiment

In this embodiment, an example configuration of a digital still camera whose imaging element includes an image encoder will be described.

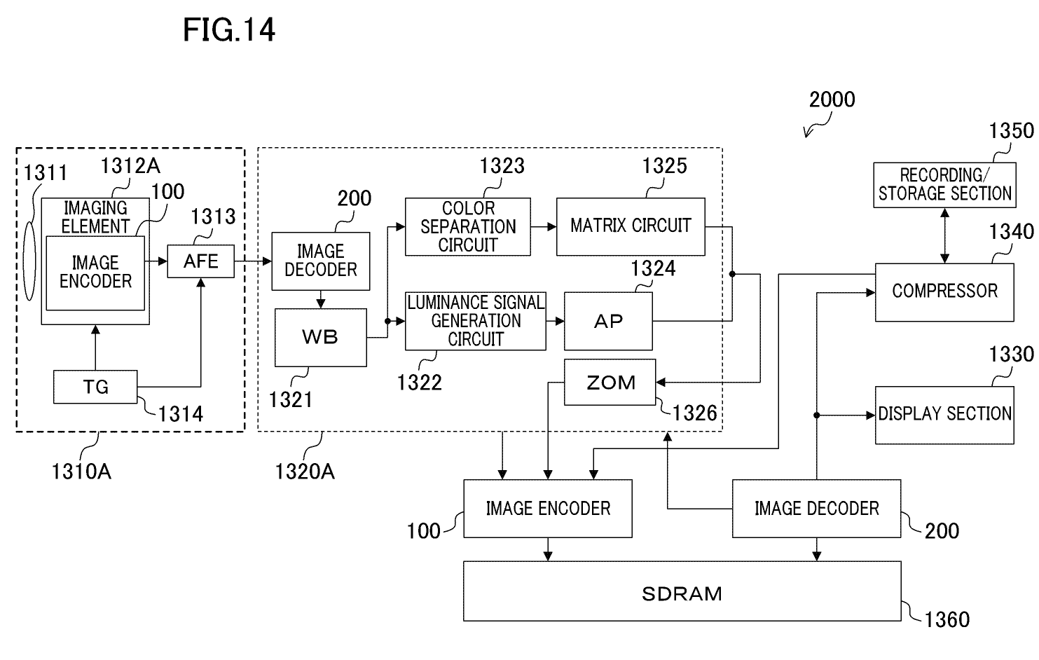

FIG. 14 is a block diagram showing a configuration of a digital still camera 2000 according to a third embodiment. As shown in FIG. 14, the digital still camera 2000 is similar to the digital still camera 1300 of FIG. 13, except that an imager 1310A is provided instead of the imager 1310, and an image processor 1320A is provided instead of the image processor 1320.

The imager 1310A is similar to the imager 1310 of FIG. 13, except that an imaging element 1312A is provided instead of the imaging element 1312. The imaging element 1312A includes the image encoder 100 of FIG. 1.

The image processor 1320A is similar to the image processor 1320 of FIG. 13, except that the image decoder 200 of FIG. 10 is further provided.

The image encoder 100 included in the imaging element 1312A encodes a pixel signal generated by the imaging element 1312A, and outputs the encoded data to the image decoder 200 included in the image processor 1320A.

The image decoder 200 included in the image processor 1320A decodes data received from the image encoder 100. By this process, the efficiency of data transfer between the imaging element 1312A, and the image processor 1320A included in the integrated circuit, can be improved.

Therefore, the digital still camera 2000 of this embodiment can achieve high-speed shooting operation with an increased number of images having the same resolution which can be shot in a single burst, an enhanced resolution of a moving image, etc., using the same memory capacity.

### Fourth Embodiment

In general, printers are required to produce printed matter with high accuracy and high speed. Therefore, the following process is normally performed.

Initially, a personal computer compresses (encodes) digital image data to be printed, and transfers the resultant encoded data to a printer. Thereafter, the printer decodes the received encoded data.

Images to be printed have recently contained a mixture of characters, graphics, and nature images as in the case of posters, advertisements, etc. In such images, a sharp change in concentration occurs at boundaries between characters or graphics and natural images. In this case, when a quantization width corresponding to a greatest of a plurality of difference values in a group is calculated, all pixels in the group are affected by that influence, resulting in a large quantization width. Therefore, even when quantization is not substantially required (e.g., data of an image indicating a monochromatic character or graphics), an unnecessary quantization error is likely to occur. Therefore, in this embodiment, the image encoder 100 of the first embodiment is provided in a personal computer, and the image decoder 200 of the first embodiment is provided in a printer, whereby a degradation in the image quality of printed matter is reduced or prevented.

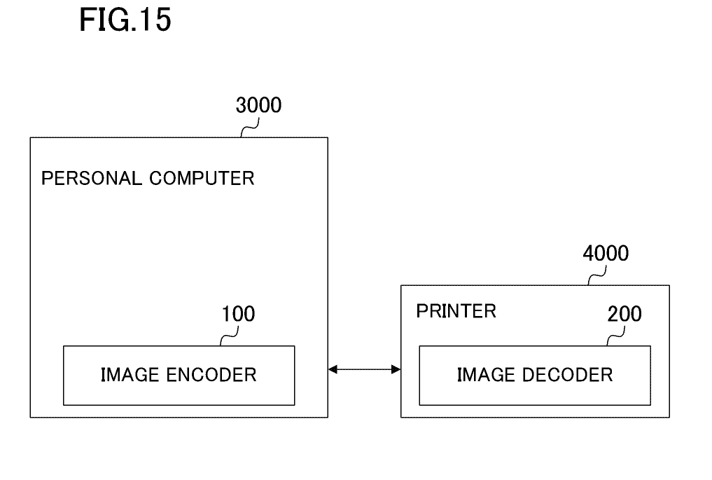

FIG. 15 is a diagram showing a personal computer 3000 and a printer 4000 according to the fourth embodiment. As shown in FIG. 15, the personal computer 3000 includes the image encoder 100, and the printer 4000 includes the image decoder 200.

Because the image encoder 100 of the first embodiment is provided in the personal computer 3000, and the image decoder 200 is provided in the printer 4000, a quantization width can be decided on a pixel-by-pixel basis, whereby a quantization error can be reduced or prevented to reduce or prevent a degradation in the image quality of printed matter.

### Fifth Embodiment

In this embodiment, an example configuration of a surveillance camera which receives image data output from the image encoder 100 will be described.

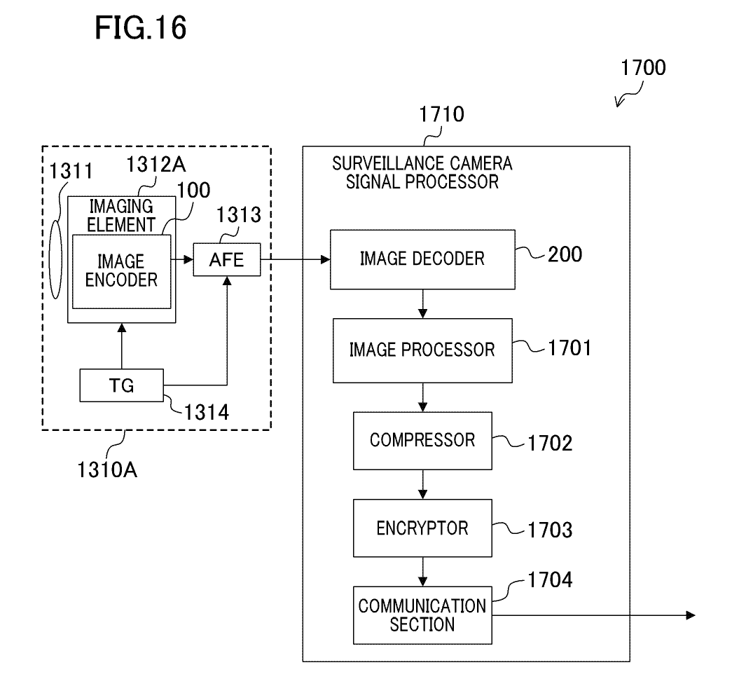

In surveillance cameras, image data is typically encrypted in order to ensure the security of the image data transmitted on a transmission path by the surveillance camera so that the image data is protected from the third party. Therefore, as in a surveillance camera 1700 shown in FIG. 16, image data which has been subjected to predetermined image processing by an image processor 1701 in a surveillance camera signal processor 1710 is compressed by a compressor 1702 based on a predetermined standard, such as JPEG, MPEG4, H.264, etc., and moreover, the resultant data is encrypted by an encryptor 1703 before being transmitted from a communication section 1704 onto the Internet, whereby the privacy of individuals is protected.

In addition, as shown in FIG. 16, an output of the imager 1310A including the image encoder 100 is input to the surveillance camera signal processor 1710, and then decoded by the image decoder 200 included in the surveillance camera signal processor 1710, whereby image data captured by the imager 1310A can be pseudo-encrypted. Therefore, the security on the transmission path between the imager 1310A and the surveillance camera signal processor 1710 can be ensured, and therefore, the security level can be improved compared to the conventional art.

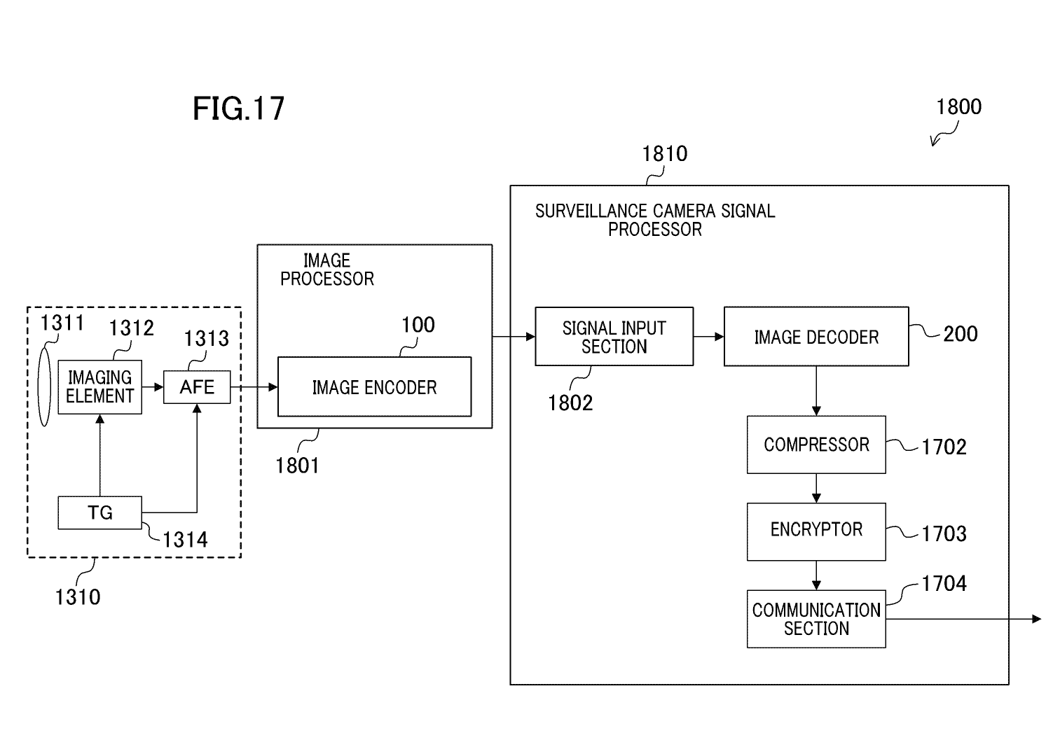

The surveillance camera may be implemented as follows. A surveillance camera 1800 of FIG. 17 includes an image processor 1801 which performs predetermined camera image processing on an input image received from the imager 1310, and a surveillance camera signal processor 1810 which includes a signal input section 1802, and receives and compresses image data received from the image processor 1801, encrypts the resultant image data, and transmits the resultant image data from the communication section 1704 to the Internet. The image processor 1801 and the surveillance camera signal processor 1810 are implemented by separate LSIs.

In this form, the image encoder 100 is provided in the image processor 1801, and the image decoder 200 is provided in the surveillance camera signal processor 1810, whereby the image data transmitted from the image processor 1801 can be pseudo-encrypted. Therefore, the security on the transmission path between the image processor 1801 and the surveillance camera signal processor 1810 can be ensured, and therefore, the security level can be improved compared to the conventional art.

Therefore, according to this embodiment, high-speed shooting operation can be achieved. For example, the efficiency of data transfer of the surveillance camera can be improved, the resolution of a moving image can be enhanced, etc. Moreover, by pseudo-encrypting image data, the security can be enhanced. For example, the leakage of image data can be reduced or prevented, the privacy can be protected, etc.

In the image encoder and the image decoder of the present disclosure, a quantization width can be decided on a pixel-by-pixel basis, and no additional bit is required for quantization width information etc., i.e., fixed-length encoding can be performed. Therefore, images can be compressed while guaranteeing a fixed bus width for data transfer in an integrated circuit.

Therefore, in devices which deal with images, such as digital still cameras, network cameras, printers, etc., image data can be encoded and decoded while maintaining the random access ability and reducing and preventing a degradation in image quality. Therefore, it is possible to catch up with a recent increase in the amount of image data to be processed.

What is claimed is:

1. An image encoder for receiving pixel data having a dynamic range of N bits, nonlinearly quantizing a difference between a pixel to be encoded and a predicted value to obtain a quantized value, and representing encoded data containing the quantized value by M bits, to compress the pixel data into a fixed-length code, where N and M are each a natural number and N>M, the image encoder comprising:
a predicted pixel generator configured to generate a predicted value based on at least one pixel located around the pixel to be encoded;
an encoded predicted value decider configured to predict, based on a signal level of the predicted value, an encoded predicted value which is a signal level of the predicted value after encoding;
a difference generator configured to obtain a prediction difference value which is a difference between the pixel to be encoded and the predicted value;
a quantization width decider configured to decide a quantization width based on the number of digits of an unsigned integer binary value of the prediction difference value;
a value-to-be-quantized generator configured to generate a value to be quantized by subtracting a first offset value from the prediction difference value;
a quantizer configured to quantize the value to be quantized based on the quantization width decided by the quantization width decider; and
an offset value generator configured to generate a second offset value,
wherein
a result of addition of a quantized value obtained by the quantizer and the second offset value is added to or subtracted from the encoded predicted value, depending on the sign of the prediction difference value, to obtain the encoded data.

2. The image encoder of claim 1, wherein
the encoded predicted value has a dynamic range of M bits.

3. The image encoder of claim 1, wherein
when the number of digits of the unsigned integer binary value of the prediction difference value is d, the first offset value is 2̂(d−1).

4. The image encoder of claim 1, wherein
as the quantization width decided by the quantization width decider increases, the second offset value also increases based on a predetermined expression.

5. The image encoder of claim 1, wherein
when the quantization width decided by the quantization width decider is zero, the first offset value and the second offset value are both zero.

6. The image encoder of claim 1, wherein
when the sign of the prediction difference value is plus, the addition result of the quantized value and the second offset value is added to the encoded predicted value, and when the sign of the prediction difference value is minus, the addition result of the quantized value and the second offset value is subtracted from the encoded predicted value, to obtain the encoded data.

7. The image encoder of claim 1, wherein
the dynamic range of M bits of the encoded data is varied, depending on the capacity of a memory device configured to store the encoded data.

8. The image encoder of claim 1, wherein
the pixel data is RAW data input from an imaging element.

9. The image encoder of claim 1, wherein
the pixel data is a YC signal produced from RAW data input from an imaging element.

10. The image encoder of claim 1, wherein
the pixel data is a YC signal obtained by decompressing a JPEG image.

11. An image decoder for receiving encoded data of M bits, and inverse-quantizing the encoded data, to decode the encoded data into pixel data having a dynamic range of N bits, where N and M are each a natural number and N>M, the image decoder comprising:
a predicted pixel generator configured to generate a predicted value based on at least one already-decoded pixel located around a pixel to be decoded;
an encoded predicted value decider configured to predict, based on a signal level of the predicted value, an encoded predicted value which is a signal level of the predicted value before decoding;
a difference generator configured to obtain a prediction difference value which is a difference between the encoded data and the predicted value;
a value-to-be-quantized generator configured to generate a value to be quantized by subtracting a first offset value from the prediction difference value;
a quantization width decider configured to decide a quantization width for inverse quantization based on the prediction difference value;
an offset value generator configured to generate a second offset value based on the quantization width; and
an inverse-quantizer configured to inverse-quantize the value to be quantized based on the quantization width,
wherein
a result of addition of an inverse-quantized value obtained by the inverse quantizer and the second offset value is added to or subtracted from the predicted value, depending on the sign of the prediction difference value, to obtain the decoded pixel data.

12. The image decoder of claim 11, wherein
the encoded predicted value has a dynamic range of M bits.

13. The image decoder of claim 11, wherein
As the prediction difference value obtained by the difference generator increases, the first offset value also increases based on a predetermined expression.

14. The image decoder of claim 11, wherein
when the number of digits of an unsigned integer binary value of the inverse-quantized prediction difference value obtained based on the quantization width is d, the second offset value is 2̂(d−1).

15. The image decoder of claim 11, wherein
when the quantization width decided by the quantization width decider is zero, the first offset value and the second offset value are both zero.

16. The image decoder of claim 11, wherein
when the sign of the prediction difference value is plus, the addition result of the inverse-quantized value and the second offset value is added to the predicted value, and when the sign of the prediction difference value is minus, the addition result of the inverse-quantized value and the second offset value is subtracted from the predicted value, to obtain the decoded pixel data.

17. An image encoding method for receiving pixel data having a dynamic range of N bits, nonlinearly quantizing a difference between a pixel to be encoded and a predicted value to obtain a quantized value, and representing encoded data containing the quantized value by M bits, to compress the pixel data into a fixed-length code, where N and M are each a natural number and N>M, the method comprising:
a predicted pixel generating step of generating a predicted value based on at least one pixel located around the pixel to be encoded;
an encoded predicted value calculating step of predicting, based on a signal level of the predicted value, an encoded predicted value which is a signal level of the predicted value after encoding;
a difference generating step of obtaining a prediction difference value which is a difference between the pixel to be encoded and the predicted value;
a quantization width deciding step of deciding a quantization width based on the number of digits of an unsigned integer binary value of the prediction difference value;
an offset value calculating step of generating a first offset value and a second offset value;
a value-to-be-quantized generating step of generating a value to be quantized by subtracting the first offset value from the prediction difference value; and
a quantizing step of quantizing the value to be quantized based on the quantization width decided by the quantization width deciding step,
wherein
a result of addition of a quantized value obtained by the quantizing step and the second offset value is added to or subtracted from the encoded predicted value, depending on the sign of the prediction difference value, to obtain the encoded data.

18. An image decoding method for receiving encoded data of M bits, and inverse-quantizing the encoded data, to decode the encoded data into pixel data having a dynamic range of N bits, where N and M are each a natural number and N>M, the method comprising:
a predicted pixel generating step of generating a predicted value based on at least one already-decoded pixel located around a pixel to be decoded;
an encoded predicted value calculating step of predicting, based on a signal level of the predicted value, an encoded predicted value which is a signal level of the predicted value before decoding;
a difference generating step of obtaining a prediction difference value which is a difference between the encoded data and the predicted value;
a quantization width deciding step of deciding a quantization width for inverse quantization based on the prediction difference value;
an offset value calculating step of generating a first offset value and a second offset value;
a value-to-be-quantized generating step of generating a value to be quantized by subtracting the first offset value from the prediction difference value; and
an inverse-quantizing step of inverse-quantizing the value to be quantized based on the quantization width decided by the quantization width deciding step,
wherein
a result of addition of an inverse-quantized value obtained by the inverse quantizing step and the second offset value is added to or subtracted from the predicted value, depending on the sign of the prediction difference value, to obtain the decoded pixel data.

19. A digital still camera comprising:
the image encoder of claim 1; and
the image decoder of claim 11.

20. A digital camcorder comprising:
the image encoder of claim 1; and
the image decoder of claim 11.

21. An imaging element comprising:
the image encoder of claim 1.

22. A printer comprising:
the image decoder of claim 11.

23. A surveillance camera comprising:
the image decoder of claim 11.
